(19) United States
(12) Patent Application Publication
(10) Pub. No.: US 2015/0269634 A1
(43) Pub. Date: Sep. 24, 2015

(54) SYSTEM AND METHOD FOR PUBLISHING PERSONALIZED BOOK COLLECTIONS

(71) Applicant: KOBO Incorporated, Toronto (CA)

(72) Inventors: Ghazaleh ETEZAL, Toronto (CA); Anthony O'DONOGHUE, Toronto (CA)

(73) Assignee: KOBO Incorporated, Toronto (CA)

(21) Appl. No.: 14/222,480

(22) Filed: Mar. 21, 2014

(51) Int. Cl. G06Q 30/02; G06F 17/22

(52) U.S. Cl. CPC G06Q 30/0276; G06F 17/2235; G06Q 30/0282; G06Q 30/0277; G06Q 30/0214

(57) ABSTRACT

System and method of publishing a personal collection of electronic books responsive to a user request. A graphical user interface (GUI) is configured to allow a user to compile a collection of electronic books and then request to share the collection to other users of a select website. In response to the request, a personal collection webpage is automatically generated and made accessible to the public users of the website through a hyperlink. The public users may submit subscribing requests through the webpage for receiving update notifications. The creator-user of a published personal collection may receive an incentive based on the number of subscribers of the collection, and the volume of books included in the collection and purchased by the subscribers.

### TECHNICAL FIELD

The present disclosure relates generally to the field of electronic books, and, more specifically, to the field of sharing electronic book related information among reader-users.

### BACKGROUND

The use of electronic devices to read books, newspapers and magazines in electronic form has become increasingly commonplace due to the numerous significant advantages afforded by such devices over conventional paper print. For example, comparing to paper print, an electronic reading device can hold greater amounts of information, allow immediate access to new books, personalize the reading display format, and facilitate night reading, etc. Electronic reading devices can be implemented as dedicated reading devices, e.g., e-readers, as well as general-purpose electronic devices, such as desktop, laptop and hand-held computers.

Now, virtually all published digital content (or electronic media products) are available through the Internet, including electronic books (ebooks), e-newspapers and e-magazines, music, video, etc. For example, readers of electronic books can obtain access to book content by purchasing and/or downloading media from an on-line book store or other content provider websites.

A user looking for a new electronic media product to explore is often overwhelmed by the available options in the market. The user's choice can be significantly influenced by other users' reviews or recommendations based on their own reading, listening, and viewing experiences. Typically, if a user finds a recommended product suits his or her taste, the user usually is interested in seeing more recommendations from the same source.

On-line reading communities hosted by various entities (e.g., book stores, universities, social network, and reading clubs) provide convenient forums for readers to communicate and share their reading experiences. Moreover, various application programs installed on electronic reading devices and the associated servers provide convenient marketing channels for promoting the sales of ebooks to users.

A user organizes the books that he or she previously read or wants to read into a collection through a book reading program or alike. However, a personal collection created through a book reading program is maintained as a private collection and unavailable for commercial exploitation.

### SUMMARY OF THE INVENTION

Therefore, it would be advantageous to provide a mechanism to facilitate communications among users of electronic media products to promote sales thereof. A collection of reading lists may be influential to other users' reading choices and consequently have an economic impact on the book distributors.

Accordingly, embodiments of the present disclosure employ a computer implemented method of publishing a personal collection of electronic media products (e.g., electronic books) responsive to a user request. A graphical user interface (GUI) is configured to allow a user to create and edit a collection of electronic books and then request to share the collection to other users of a select website. Responsive to a sharing request, a personal collection webpage is automatically generated and made accessible to public users of the website through a hyperlink. The public users may submit subscribing requests through the webpage for receiving a notification each time the personal collection is updated, for example with an added book item or new description. The creator-user of a published personal collection may receive an incentive from the website based on the number of subscribers to the collection, and further based on the volume of books included in the collection and/or purchased by the subscribers.

According to one embodiment of the present disclosure, a computer implemented method of publishing a personalized selection of electronic media products comprises: (1) receiving a publishing request from a first user for publishing said personalized selection of electronic media products, wherein said personalized selection comprises identifications of a plurality of electronic media products that are selected by said first user, and wherein said first user is a registered user of a website; (2) accessing said personalized selection responsive to said publishing request; (3) generating a webpage comprising said personalized selection and an identification of said first user; (4) associating a hyperlink with said webpage; and (5) enabling said webpage to be publicly accessible, e.g., to all registered users of said website through said hyperlink.

The method may further comprise: receiving text input from said first user, said text input describing said personalized selection; and receiving a tag input from said first user, said tag input categorizing said personalized selection, wherein said webpage further comprises said text input and said tag input. The method may further comprise: receiving an indication that said personalized selection is updated with a new electronic product; accessing said personalized selection responsive to said indication; and updating said webpage with an identification of said new electronic media product.

The method may further comprise: receiving a subscription request from a subscriber with respect to said personalized selection; and sending an update notification to said subscriber with respect to said new electronic media product upon said updating said webpage. The method may further comprises: awarding a credit to said first user based on a number of subscription requests received with respect to said personalized selection; and/or awarding based on a number of purchases made by subscribers of said personalized selection and on electronic media products that are included in said personalized selection, wherein said credit corresponds to a monetary value.

According to one embodiment of the present disclosure, a non-transitory computer-readable storage medium embodying instructions that, when executed by a processing device, cause the processing device to perform a method of publishing a personal collection of electronic books. The method comprises: (1) rendering a first graphical user interface (GUI) for display on a user device, wherein said first GUI is configured to: receive user input from a first user to identify a collection of electronic books; wherein said first user is a registered user of a website; and receive a user instruction from said first user to publish said collection of electronic books on a website; (2) responsive to said user instruction, generating indications operable to generate a webpage comprising identifications of said collection of electronic books and an identification of said first user; establish a hyperlink with said webpage; and enabling said webpage to be accessible to all registered users of said website via said hyperlink; and (3) sending said indications through a communication channel to a server device that hosts said website.

According to one embodiment of the present disclosure, a system comprises: a communication circuit; a processor coupled to said communication circuit; memory coupled to said processor and comprising instructions that, when executed by said processor, cause the system to perform a method comprising: (1) rendering a first graphical user interface (GUI) for display; (2) receiving a publishing request from a first user through said first GUI for publishing a personalized selection of electronic media products, wherein said personalized selection comprises identifications of a plurality of electronic media products that are selected by said first user, and wherein said first user is registered with a website; (3) accessing said personalized selection responsive to said publishing request; (4) generating a webpage comprising visual objects representing said personalized selection of electronic media products and an identification of said first user; (5) associating a hyperlink with said webpage; and (6) enabling said webpage to be accessible to all users of said website through said hyperlink.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates an exemplary system configured to allow a personal selection of electronic media products to be published to a wide audience on a select website in accordance with an embodiment of the present disclosure.

FIG. 2 is a flow chart depicting an exemplary computer implemented method of generating a personal selection of electronic media products for publication based on user input in accordance with an embodiment of the present disclosure.

FIG. 3 is a flow chart illustrating an exemplary computer implemented method of publishing a personal collection of electronic media products on a select website in accordance with an embodiment of the present disclosure.

FIG. 4 illustrates an exemplary on-screen GUI configured to receive user instructions to establish and publish a personal collection in accordance with an embodiment of the present disclosure.

FIG. 5 illustrates exemplary on-screen GUI windows configured to receive user selections for a public personal collection and display the public personal section according to an embodiment of the present disclosure.

FIG. 6 illustrates the editing GUI windows configured to allow a user to edit a public personal collection in accordance with an embodiment of the present disclosure.

FIG. 7 illustrates an exemplary webpage presenting a personal selection of electronic books to public viewers of a bookstore website in accordance with an embodiment of the present disclosure.

FIG. 8 illustrates an exemplary webpage presenting detailed information regarding a book item selected from a personal selection in accordance with an embodiment of the present disclosure

FIG. 9 is a block diagram illustrating an exemplary computing system including personal collection management program capable of publishing personal collections through a select website in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### System and Method for Publishing Personalized Book Collections

Overall, embodiments of the present disclosure employ a computer implemented method of publishing a personal selection (or collection) of electronic media products compiled by a computer through a select website responsive to a user request. The personal selection can be generated through a graphical user interface (GUI) configured to receive user input with respect to selections of electronic media products. The user can then send a command through the GUI to publish his or her personal selection to a wide audience of other users on a selected website, e.g., an on-line book distributor. In response, a webpage identifying the personal selection and the user can be automatically generated and posted on the website. Viewers of the webpage may submit subscribing requests so as to be apprised of any update to the personal collection. The user creating the personal selection may receive rewards for advertizing and/or promoting the books to the subscribers.

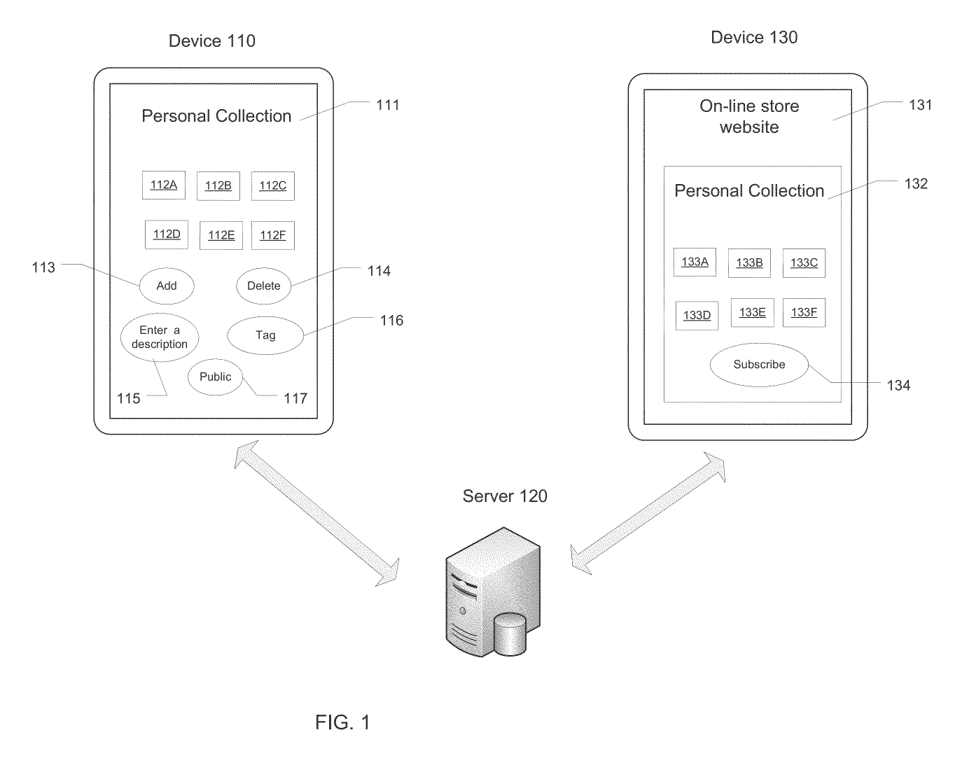

FIG. 1 illustrates an exemplary system 100 configured to allow a personal selection of electronic media products compiled by a user to be published on a select website in accordance with an embodiment of the present disclosure. System 100 includes a user device 110, a user device 130 and a server device 120 coupled to the user devices 110 and 130 through a communication network. In this example, the server device 120 is configured to manage an on-line website store.

The user device 110 is a computer system and is installed with an application program configured to receive user input through an on-screen GUI 111 with respect to compiling a personal selection of electronic media products. In the illustrated example, media products 112A-112F are listed in the personal selection based on the user input. According to the present disclosure, the GUI 111 is configured to receive a request from the creator-user of the personal selection to make the personal selection public, e.g., sharing it with a wide audience of other users of the on-line book store website. Such a request can be submitted via a user interaction with the clickable button “Public” 117 in the GUI 111.

As shown, the GUI 111 also has features configured to allow the creator-user of the personal selection to add an item to the list via the button “Add” 113; delete an item from the list via the button “Delete” 114; add a personal description about the selection via the button “Enter a description” 115; and tag the selection using one or more categories via the button “Tag” 116. Therefore, the personal selection can be modified by the user.

In response to the user instruction for publication, the device 110 generates and sends a publication indication to the server device 120 through a communication network. The server device 120 can access the personal selection from the user device 110 and generate a webpage 132 including the identified items (represented by the visual objects 133A-133F) in the personal selection as well as the identification of the creator-user. The webpage 132 is then posted on the book store website 131 and become discoverable and accessible to viewers of the website, e.g., through the user device 130. In this way, the personal selection is capable of being discovered by device 130, e.g. via a search engine.

The webpage 132 has a feature 134 that allows a viewer to subscribe the particular personal collection, for example, because the viewer finds the personal selection informative and helpful for discovering future reading materials, or because the viewer recognizes the creator-user as a friend or otherwise trusted to have good selections. Therefore, the publication of a personal selection can provide significantly expansive exposure of the items included therein, and thereby can effectively promote the marketing of these items to a wide audience.

According to the present disclosure, a creator of a personal collection can be any type of user, e.g., an average user of the website, an author, a celebrity, a publisher, an editor, a teacher or a book club, for instance.

The user devices can be any type of computing devices, e.g., desktops, tablets, laptops, electronic readers, and hand-held computers. The electronic media products may include ebooks, e-newspapers and e-magazines, MP3 music, music CDs, videos, DVDs, etc.

A personal collection may include items such as electronic media products that are purchased, viewed, downloaded, desired, and/or favored by the creator-user. A personal collection may include a sub-collection that are composed by another user or automatically generated based on certain criteria (e.g., by a particular author). For instance, a user may discover a list of books by Shakespeare and add the list as a sub-collection to his or her personal collection. The sub-collection could also contain another collection.

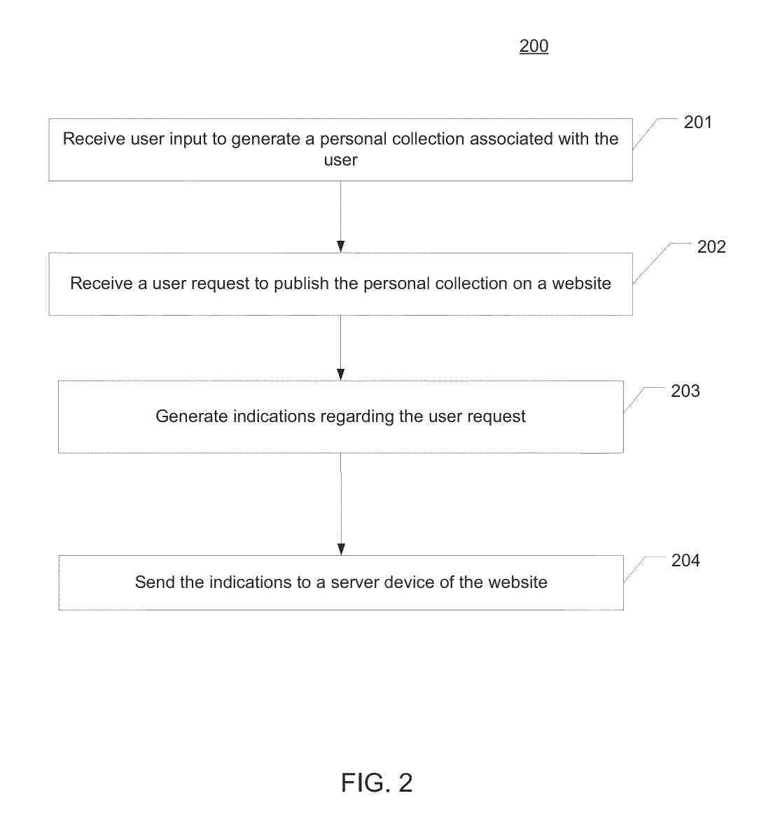

FIG. 2 is a flow chart depicting an exemplary computer implemented method 200 of generating a personal selection of electronic media products for publication based on user input in accordance with an embodiment of the present disclosure. Method 200 can be implemented as an application program installed in a device (e.g., device 110 in FIG. 1) accessible to a creator-user of the personal selection. Alternatively, method 200 can be implemented in a server device (e.g., device 120 in FIG. 1) remotely accessible by a creator-user of the personal selection, for example through the website hosted by the server device. Method 200 can run on any operating system platform installed on the associated device, such as iOS, Android, Windows, Linux, or MAC OS.

At 201, a series of user inputs that identifies the items to be included in a personal collection is received from a creator-user. Based on the inputs, a personal collection is generated (or updated) and recorded in a local storage unit (e.g., coupled to the user device) and/or a remote storage unit (e.g., coupled to the server device). Typically the collection can only be accessed by the user at 201.

As the personal collection is linked to a specific creator-user, an identification authentication process may be initiated when the creator-user indicates to create a new personal collection or to edit an existing one.

It will be appreciated that the user inputs with respect to the selection may be received in various manners depending on the implementations of the method 200, such as through a GUI or a separate text compiler. A GUI (e.g., GUI 111 in FIG. 1) capable of generating a personal collection may be an integral part of a book reading program that is implemented on an electronic reading device (e.g., device 110). The book reading program may be configured to display book content well as receive user input to compose a selection of books according to the present disclosure. Alternatively, the GUI may be associated with an application program dedicated to generate personal collections based on the user inputs.

At 202, a user request is received to publish the personal collection to a wide audience of users on the select website. Absent such a specific request for publication, the personal collection generally remains private and so accessible only to the creator-user (creator of the personal collection).

At 203, the user request is processed to generate indications informing a server device that the select website needs to generate or update the public webpage for the personal selection. At 204, the indications are sent to the server device.

The forgoing steps 201-204 are repeated each time the personal collection is updated by the creator-user. Further, a published personal selection may be withdrawn from the publication and so the webpage is taken off from the website, in response to a request from the creator-user.

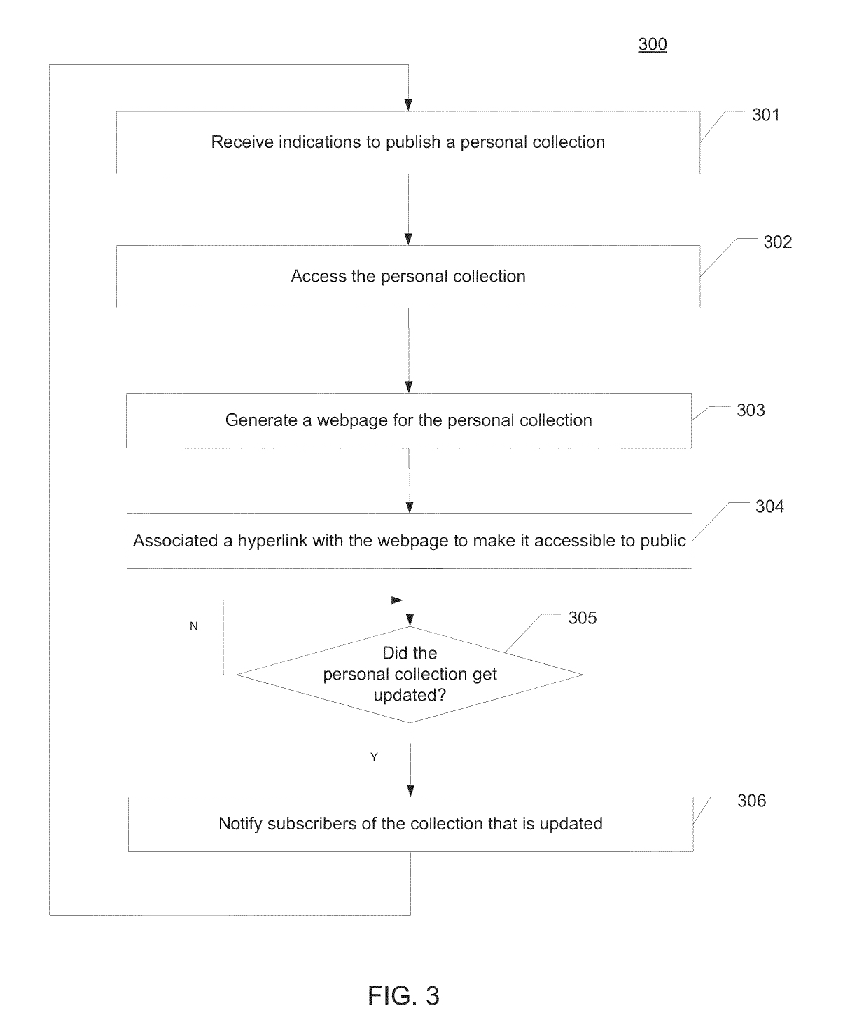

FIG. 3 is a flow chart illustrating an exemplary computer implemented method 300 of publishing a personal collection of electronic media products on a select website in accordance with an embodiment of the present disclosure. Method 300 may be implemented on a server device (e.g., device 120 in FIG. 1) that hosts the website. In some embodiments, method 200 and 300 are implemented on a single device. In some other embodiments, method 200 is implemented in a user device while method 300 is implemented in a remote server device, as illustrated in FIG. 1.

At 301, the indications regarding a creator-user's request to publish a personal collection is received, e.g., from a user device 110 in FIG. 1. At 302, the personal collection is accessed, e.g. from a local storage drive or from a remotely storage device coupled to or within a user device through the network. At 303, a webpage for the personal selection is then generated, e.g., in accordance with a predetermined webpage template or wireframe. At 304, the webpage is associated with a public hyperlink and thereby made accessible to the public, e.g., to a wide audience of users of the select website. As a result, the public users who visit the webpage can view the personal collection.

If it is determined that the personal collection gets updated at 305, a notice will be sent to subscribers of the collection about the update at 306 and the foregoing 301-304 is repeated for publishing the updated collection.

In addition, public users may be allowed to subscribe to the personal collection by submitting a subscribing request through the webpage. The subscriber-users can then receive notifications regarding any update on the personal collection, such as an update on the listed items, description, or tags.

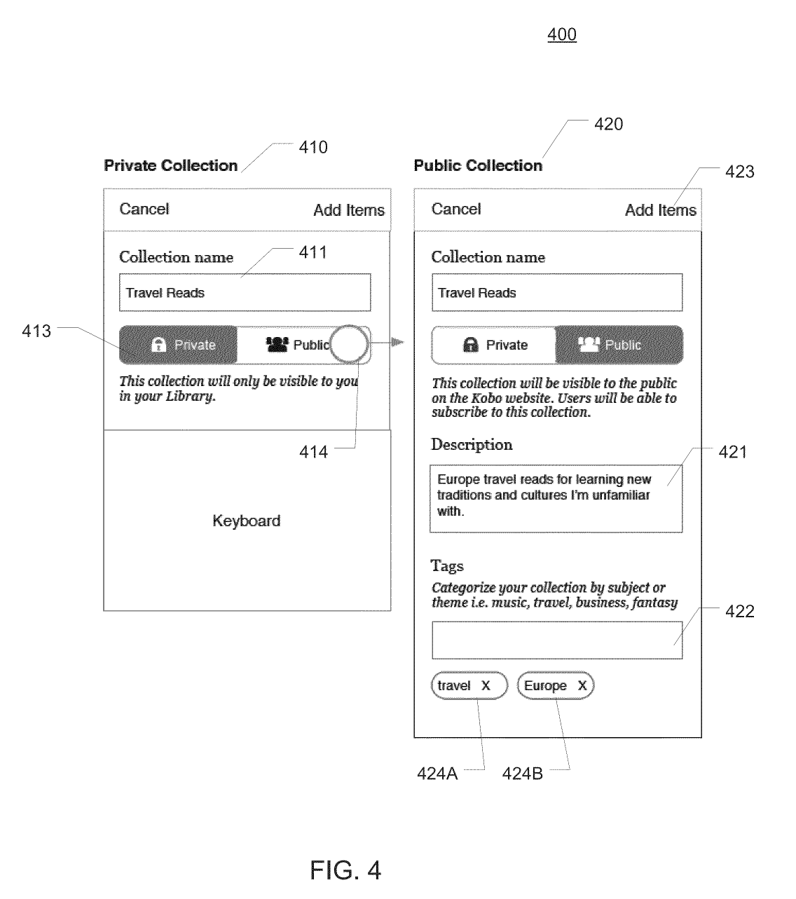

FIG. 4 illustrates an exemplary on-screen GUI 400 configured to receive user instructions to establish and publish a personal collection in accordance with an embodiment of the present disclosure. When the user initially instructs to establish a new personal collection or open an existing one, the “Private Collection” GUI window 410 is displayed. The GUI window 410 includes a text entry area 411 allowing the user to compile a collection name. The user may select the “Add items” button 412 to add items to the list.

The GUI window 410 includes a “Private” button 413 and a “Public” button 414, through which the user can elect to make the personal selection private or public. If the user clicks the “Public button” 414, the “Public collection” GUI window 420 is displayed, which additionally includes a “Description” field 421 and a “Tags” field 422. The “Description” field 421 allows a user to enter a detailed explanation or description of the personal collection.

The “Tags” field 422 is configured to allow a user to attach one or more key words or categories to the personal collection, for example by selecting from an options menu or text entry. In the illustrated example, the personal selection is categorized as “travel” and “Europe.” The tags associated with a personal selection can be used to for purposes of organizing and increasing the discoverability on the Internet, e.g., by various search engines.

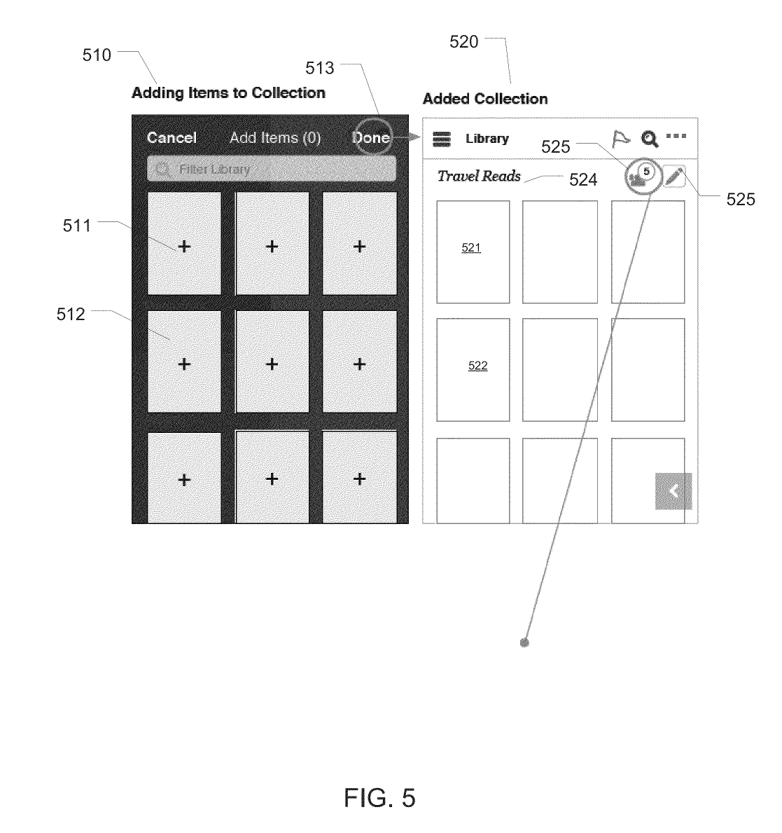

If a user clicks an “Add items” button (412 or 423) in either GUI window (410 or 420), another GUI window (e.g., 510 in FIG. 5) may be displayed allowing the user to select items from a library to add to the list. FIG. 5 illustrates exemplary on-screen GUI windows 510 and 520 configured to receive user selections for a public personal collection and display the public personal section according to an embodiment of the present disclosure. The GUI window 510 displays visual objects (e.g., 511 and 512) representing electronic media files included in a library or directory that is specified by the user. The user can click one or more visual objects to add to the collection.

When the user clicks the “Done” button 513, the GUI window 510 is closed and the personal collection overview window 520 is opened. The GUI window 520 includes a title 524 for the collection, and visual objects (e.g., book covers) representing the selected items (e.g., 521 and 522). The GUI window 520 also has an on-screen indicator 523 showing the number of subscribers of the personal collection.

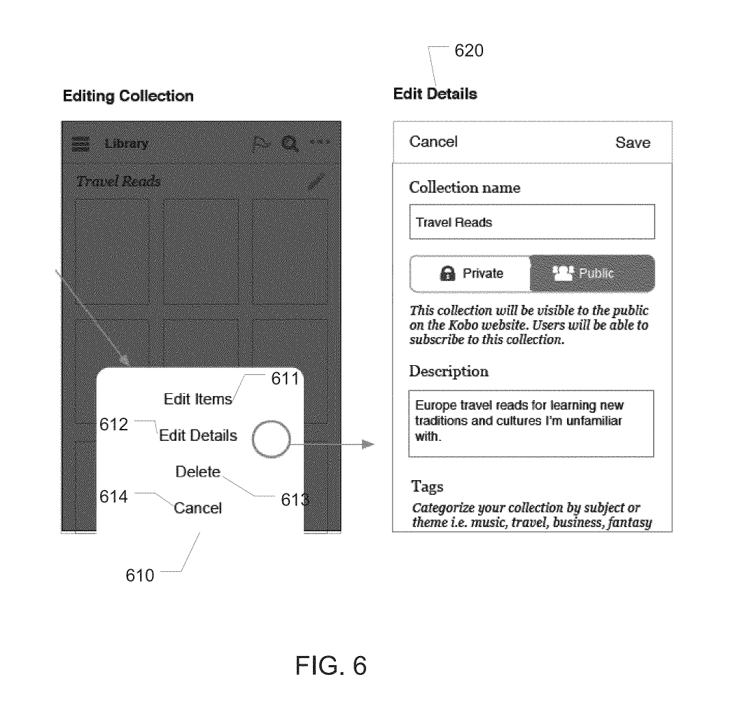

The GUI window 520 has an icon 525 linked to editing tools for the personal collection. FIG. 6 illustrates the editing GUI windows configured to allow a user to edit a public personal collection in accordance with an embodiment of the present disclosure. If a user clicks the icon 525 in FIG. 5, an options menu 610 is displayed showing the options of “Edit Items” 611, “Edit Details” 612, “Delete” 613, and “Cancel” 614. If the user selects the “Edit items” 611 option, the user can add or delete items from the list, e.g., through the GUI window 510. If the user selects the “Edit Details” 612 option, the GUI widow 620 is opened, which allows the user to edit the title, accessibility, the description and the tags of the personal collection, as described in greater detail with reference to FIG. 4.

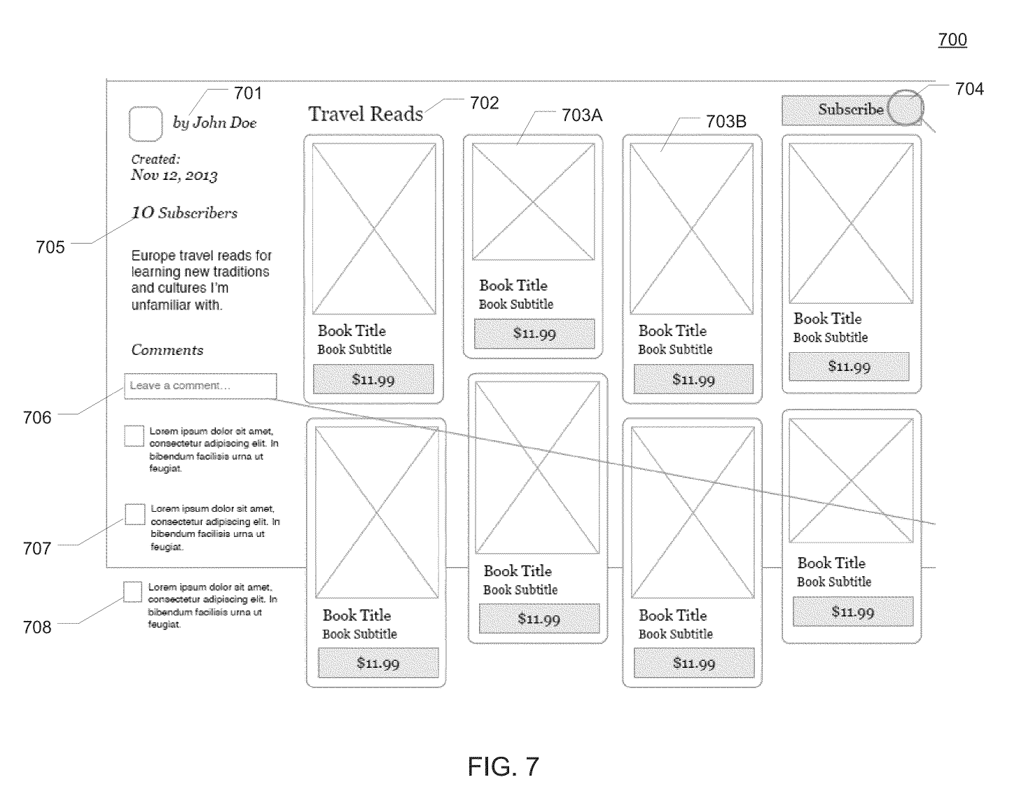

FIG. 7 illustrates an exemplary webpage diagram 700 presenting a personal selection of electronic books to public users of a bookstore website in accordance with an embodiment of the present disclosure. The webpage 700 includes the name 701 of the creator-user, the title 702 of the personal collection, the book covers of the items in the personal collection (e.g., 703A and 703B), and the number of subscribers 705 of the personal collection.

The webpage diagram 700 also includes a text entry area 706 for a viewer-user to enter a comment. In some embodiments, only authorized users, e.g., registered members who logged in with a book store account can leave a comment. The comments will become public along with the personal selection, e.g., 707 and 708.

The webpage diagram 700 includes a “Subscriber” button 704 designed to receive a viewer-user's request for subscribing the personal collection. The viewer-user may be required to have a registered account with the book store website in order to subscribe a personal collection. Then if the personal collection is updated by the creator-user, a subscriber can receive a notification.

The webpage 700 is associated with a public hyperlink and so any user will be able to access the webpage from the website or a shared link. The homepage of the website may show a few popular personal collections or have a section to browse personal collections by type.

If a viewer-user selects a book item from the personal collection (e.g., 703A or 703B) through the webpage 700, detailed information regarding the selected book can be presented.

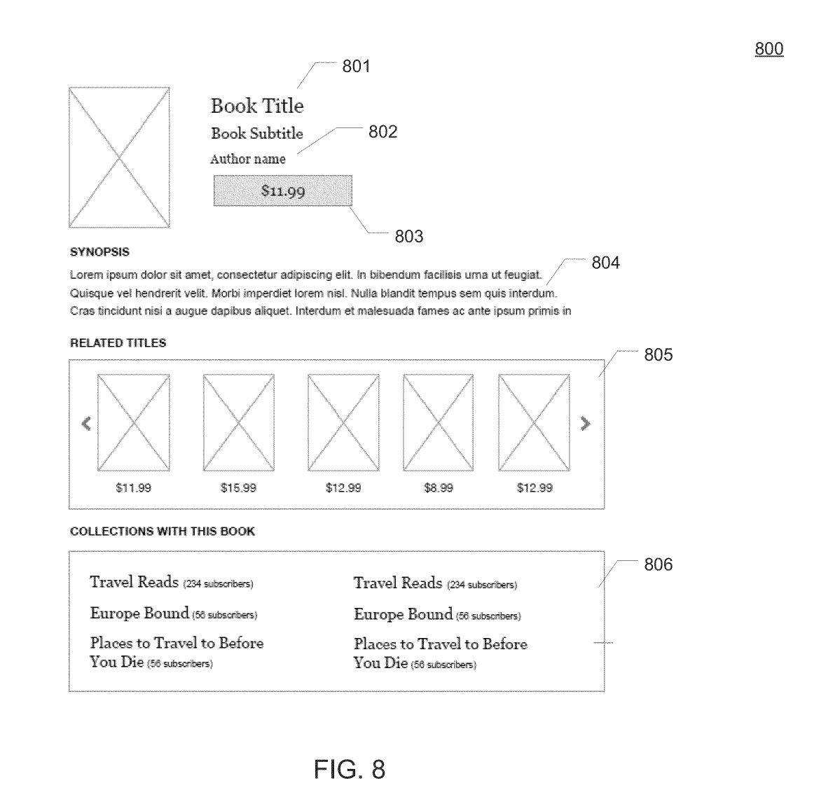

FIG. 8 illustrates an exemplary webpage diagram 800 showing detailed information regarding a book item selected from a personal selection in accordance with an embodiment of the present disclosure. The webpage diagram 800 includes the book title 801, author name 802 and the price 803. A viewer user can proceed to check out the present book item by clicking the price button. The webpage diagram 800 also includes a synopsis section 804, related book section 805, and a section 806 for collections naming this book. The section 806 appears as suggestions for more discovery of similar content.

To encourage users to create and publish quality personal collections, an incentive or credit mechanism can be implemented. The present disclosure is not limited any specific incentive mechanism used to reward users for publishing and promoting sales of electronic media products. In some embodiments, a creator-user can accumulate credit points based on the number of subscribers of a published personal collection (e.g., 2 points for 5 subscribers). If a subscriber purchased electronic media products through the personal collection webpage, the creator-user can be rewarded with additional points (e.g., 1 point for each related purchase). The points can be assigned with certain monetary values for cash or purchase credits, or any other type of privileges granted by the book store.

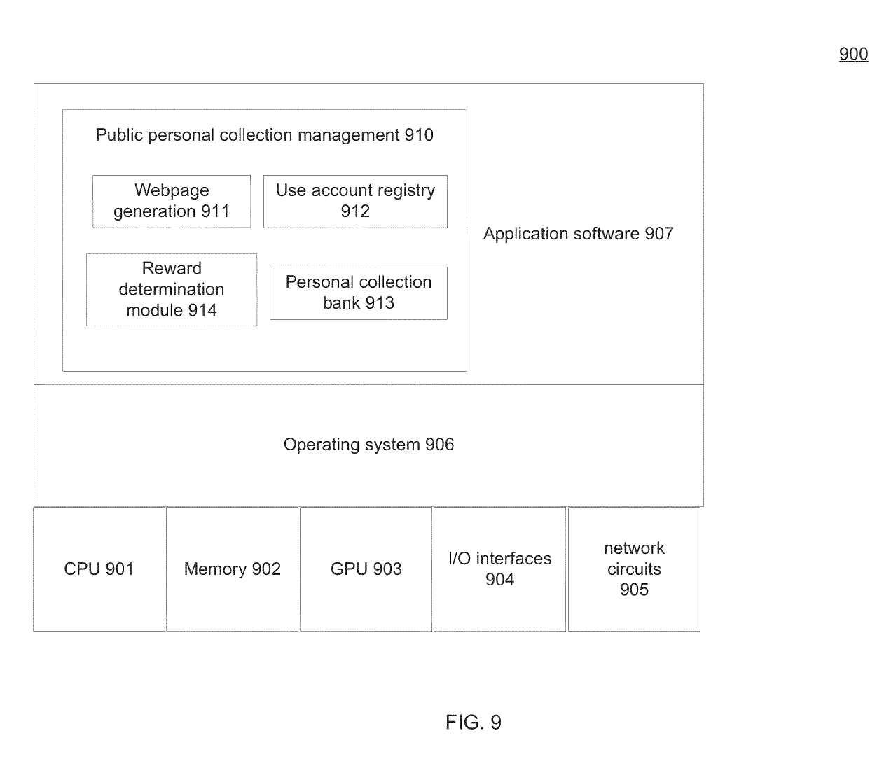

FIG. 9 is a block diagram illustrating an exemplary computing system 900 including personal collection management program 910 capable of publishing personal collections through a select website in accordance with an embodiment of the present disclosure. The computing system 900 comprises a central processing unit (CPU) 901, memory 902, a graphics processing unit (GPU) 903, I/O interfaces 904, network circuits 905, an operating system 906 and application software 907 including the personal collection management program 910 stored in the memory 902. Electronic media content can be stored in a secondary storage device associated with the computing system 900. The computing system 900 may host a book store website and is coupled to a number of user devices (e.g. 110, and 120 in FIG. 1) remotely through the network.

In the illustrated example, the personal collection management program 910 comprises a webpage generation module 911, a user account registry module 912, a personal collection bank 913, and a reward determination module 914. When incorporating configuration input and personalized input and executed by the CPU 901, the personal collection management program 910 can publish a specified personal collection responsive to a received user request. The

The user account registry stores user accounts affiliated with the book store. The user account information is used to verify the identity of a creator-user or a subscriber-user through a log-in process.

In response to receiving indications of a user request for publishing a personal selection, the webpage generation module 911 can access the specified personal selection from the personal collection bank and generate a webpage (e.g., FIG. 7) according to a predetermined template. The public webpage is associated with a public hyperlink and becomes accessible to all users of the website or even to the general public including those who do not have an account with the book store.

The reward determination module 914 is configured to assign credit points to user account based on the number of subscribers of a personal collection and the volume of sales resulted from the publication of the personal collection.

The personal collection management program 910 may perform various other functions as discussed in details with reference to FIG. 1-FIG. 8. As will be appreciated by those with ordinary skill in the art, the personal collection management program 910 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of making electronic media products available, said method comprises:
receiving a publishing request from a first user for publishing a personalized selection of electronic media products, wherein said personalized selection comprises identifications of a plurality of electronic media products that are selected by said first user, and wherein said first user is a registered user of a website;
accessing said personalized selection responsive to said publishing request;
generating a webpage comprising said personalized selection and an identification of said first user; and
associating a hyperlink with said webpage;
enabling said webpage to be accessible to other registered users of said website through said hyperlink.

2. The computer implemented method of claim 1 further comprising:
receiving text input from said first user, said text input describing said personalized selection; and
receiving a tag input from said first user, said tag input categorizing said personalized selection,
wherein said webpage further comprises said text input and said tag input.

3. The computer implemented method of claim 1 further comprising:
receiving an indication that said personalized selection is updated with a new electronic product;
accessing said personalized selection responsive to said indication; and
updating said webpage with an identification of said new electronic media product.

4. The computer implemented method of claim 3 further comprising:
receiving a subscription request from a subscriber with respect to said personalized selection; and
sending an update notification to said subscriber with respect to said new electronic media product upon said updating said webpage.

5. The computer implemented method of claim 4 further comprising awarding a credit to said first user based on a number of subscription requests received with respect to said personalized selection.

6. The computer implemented method of claim 4 further comprising awarding a credit to said first user based on a number of purchases made by subscribers of said personalized selection and on electronic media products that are included in said personalized selection, wherein said credit corresponds to a monetary value.

7. The computer implemented method of claim 1, wherein said plurality of electronic media products comprise electronic media products purchased by said first user.

8. The computer implemented method of claim 1, wherein said electronic media products are selected from a group consisting of electronic books, electronic magazines, electronic newspapers, music, videos, and audio books.

9. A non-transitory computer-readable storage medium embodying instructions that, when executed by a processing device, cause the processing device to perform a method of publishing a personal collection of electronic books, said method comprising:
rendering a first graphical user interface (GUI) for display on a user device, wherein said first GUI is configured to:
receive user input from a first user to identify a collection of electronic books;
wherein said first user is a registered user of a website; and
receive a user instruction from said first user to publish said collection of electronic books on a website;
responsive to said user instruction, generating indications operable to:
generate a webpage comprising identifications of said collection of electronic books and an identification of said first user;
store an indication that said webpage is to be published; and
enable said webpage to be accessible to other registered users of said website; and
sending said indication through a communication channel to a server device that hosts said website.

10. The non-transitory computer-readable storage medium of claim 9, wherein said website is an on-line book store.

11. The non-transitory computer-readable storage medium of claim 9, wherein said first GUI is further configured to receive user input to update said collection of electronic books by adding and/or deleting electronic books from said collection, and wherein said method further comprises sending a collection update indication to said server device through a communication channel.

12. The non-transitory computer-readable storage medium of claim 9, wherein said first GUI is configured to present a number of subscribers of said collection of electronic books, and a quantity of purchases made by said number of subscribers on electronic books that are included in said collection of electronic books.

13. The non-transitory computer-readable storage medium of claim 9, wherein said first GUI is further configured to:
receive a description input from said first user that describes said collection of electronic books; and
receive a classification input from said first user that classifies said collection of electronic books, and wherein said webpage comprises said description input and said classification input.

14. The non-transitory computer-readable storage medium of claim 9, wherein said first GUI is associated with a user account assigned to said first user.

15. The non-transitory computer-readable storage medium of claim 9, wherein said collection of electronic books comprises a subset of electronic books that are automatically selected based on predetermined criteria.

16. A system comprising:
a communication circuit;
a processor coupled to said communication circuit;
memory coupled to said processor and comprising instructions that, when executed by said processor, cause the system to perform a method comprising:
generating a first graphical user interface (GUI) for rendering to display;
receiving a publishing request from a first user through said first GUI for publishing a personalized selection of electronic media products, wherein said personalized selection comprises identifications of a plurality of electronic media products that are selected by said first user, and wherein said first user is registered with a website;
accessing said personalized selection responsive to said publishing request;
generating a webpage comprising visual objects representing said personalized selection of electronic media products and an identification of said first user;
associating a hyperlink and an identification of said user with said webpage; and
enabling said webpage to be accessible to other users of said website through said hyperlink.

17. The system of claim 16, wherein said webpage further comprises a description of said personalized selection, and a classification of said personalized selection.

18. The system of claim 16, wherein said webpage is configured to receive subscribing requests from a plurality of viewers of said webpage, and wherein said method further comprises
receiving an indication indicating that said personalized selection is updated by said first user;
updating said webpage responsive to said message; and
sending a notification with respect to said updating to said plurality of viewers.

19. The system of claim 18, wherein said method further comprises rewarding said first user based on a number of said plurality of viewers.

20. The system of claim 19, wherein said method further comprises rewarding said first user based on a number of purchases made by said plurality of viewers on electronic media product included in said personalized selection.
